(19) United States
(12) Patent Application Publication
(10) Pub. No.: US 2024/0298838 A1
(43) Pub. Date: Sep. 12, 2024

(54) CAPSULE AND SYSTEM FOR PREPARING A BEVERAGE

(71) Applicant: SOCIETE DES PRODUITS NESTLE S.A., Vevey (CH)

(72) Inventors: GILLES GAVILLET, Ursy (CH); ARNAUD GERBAULET, Oye et Pallet (FR); VEITH BEHRMANN, Villeneuve (CH)

(21) Appl. No.: 18/254,709

(22) PCT Filed: Nov. 24, 2021
(86) PCT No.: PCT/EP2021/082803

§ 371 Date: May 26, 2023

(30) Foreign Application Priority Data
Nov. 27, 2020 (EP) 20210284.4

(51) Int. Cl. A47J 31/36; A47J 31/44

(52) U.S. Cl. CPC A47J 31/368; A47J 31/4407

(57) ABSTRACT

The invention relates to capsule for preparing a beverage comprising
a substantially rigid capsule body having a circumferential sidewall extending around an inner space of the capsule, said inner space being at least partially filled with a beverage ingredient suitable for preparing the beverage,
a base wall covering the inner space at a first end of the sidewall,
a flange arranged circumferentially at a second end of the sidewall of the base body,
a lid covering the inner space at a second end of the sidewall opposite the base wall and tightly closing the capsule, and
a filter element positioned in the inner space of the capsule between the beverage ingredient and the lid; and
a carrier disk provided in the inner space of the capsule,
   wherein the lid is removably attached to the flange for use of the capsule in a beverage preparation device, and
   wherein the carrier disk is provided between the lid and the filter, said carrier disk comprising multiple preformed outlet openings suitable for draining the prepared beverage from the inner space when the capsule is used in the beverage preparation device.

The invention also relates to a system comprising said capsule to a manufacturing method for manufacturing said capsule and to the use of said capsule.

### CROSS REFERENCE TO RELATED APPLICATIONS

The present application is a National Stage of International Application No. PCT/EP2021/082803, filed on Nov. 24, 2021, which claims priority to European Patent Application No. 20210284.4, filed on Nov. 27, 2020, the entire contents of which are being incorporated herein by reference.

### FIELD OF THE INVENTION

The invention relates to a capsule for preparing a beverage comprising a substantially rigid capsule body having a circumferential sidewall extending around an inner space of the capsule which is at least partially filled with a beverage ingredient for preparing the beverage such as coffee, and a base wall covering the inner space at a first end of the sidewall, the capsule comprising a lid covering the inner space at a second end of the sidewall opposite the base wall.

The invention also relates to a system for preparing a beverage.

### BACKGROUND OF THE INVENTION

Capsules for preparing a beverage in a beverage preparation device, and presenting said features are generally known from the prior art. The beverage preparation device comprises a brewing chamber in which the capsule is positioned. Liquid from the beverage preparation device is injected in the capsule to extract the beverage from an extractable ingredient, usually roasted and ground coffee or tea, or to prepare the beverage from a soluble ingredient, usually instant coffee, instant tea or instant milk or chocolate-based product, contained within an inner space of the capsule.

In most of the capsules currently on the market, the inner space of the capsule is closed, hermetically or fluid-tightly closed from the environment prior to be use in the beverage preparation device in order to maintain or prolong a freshness of the beverage ingredient during storage.

The capsule hereto often comprises a substantially rigid capsule body having a circumferential sidewall extending around the inner space and a base wall covering the inner space at a first end of the sidewall. At a second end of the sidewall opposite the base wall the capsule body has an open filling side. A fluid and gas tight lid, for example an aluminum lid, is provided over the open filling side of the capsule body to cover the inner space. In use the capsule may be pierced, preferably at the base wall and/or the lid, to form an injection opening for injecting the liquid such as hot water, and/or to form an outlet opening which allows the prepared beverage to escape the capsule.

The known capsules are more particularly conceived for preparing an espresso type beverage using beverage preparation device delivering high pressurized hot water wherein the injection of pressurized hot water in the capsule leads to an extraction of substances from the coffee beverage ingredient and with foam forming on the beverage corresponding to an espresso beverage with a crema layer as obtained with known piston type espresso machine using high pressure brewing.

For a crema-free coffee beverage, for example a coffee beverage without foam, also referred to as filter coffee, usually specific apparatuses are used in which the beverage is prepared by unpressurized filtration of a mixture of beverage ingredient and water.

Some capsules to be used in pressurized beverage devices have been proposed for the preparation of crema free coffee.

EP 2952125 A1 discloses a capsule for preparing a beverage using an extractable product contained in an inner space of the capsule. The capsule comprises a circumferential first wall, a second wall closing the circumferential first wall at a first end, and a flexible sheet-shaped perforate and/or porous third wall closing the circumferential first wall at a second, open end opposite the second wall, thereby forming the said inner space. The third wall forms an outermost boundary of the capsule in an axial direction thereof and comprises a woven or nonwoven filtering material, such as filtering paper.

WO 2019/013623 A1 proposes a capsule comprising a rigid capsule body with a circumferential wall and a base wall that border an inner space filled with a beverage ingredient. An open filling side of the capsule at an end of the circumferential wall opposite the base wall is covered with a lid of fluid tight material. The lid is provided with a preformed outlet opening suitable for draining the prepared beverage from the inner space when the capsule is used in a beverage preparation device. The outlet opening is fluid tightly closed by a removable cover element extending over at least part of the lid.

However, these solutions are not fully satisfactory in what concerns the construction of the capsule, the ergonomic use of it by the consumer and the in-cup result.

It is therefore an object of the proposed invention to provide a capsule and system of simple construction for producing a filter type coffee with no crema which have all the characteristics of a filter coffee made with drip coffee machine.

### SUMMARY OF THE INVENTION

In this respect, the invention provides a capsule for providing a crema-free coffee, tea, milk or chocolate based beverage according to claim 1 and as described herein.

The claimed capsule is intended for preparing a beverage and comprises:
a substantially rigid capsule body having a circumferential sidewall extending
around an inner space of the capsule, said inner space being at least partially filled with a beverage ingredient suitable for preparing the beverage,
a rigid base wall covering the inner space at a first end of the sidewall, the base wall being integral with the capsule body,
a flange arranged circumferentially at a second end of the sidewall of the base body,
a lid covering the inner space at a second end of the sidewall opposite the base wall and tightly closing the capsule, and
a filter element positioned in the inner space of the capsule between the beverage ingredient and the lid; and
a carrier disk provided in the inner space of the capsule.

According to the invention, the lid of the capsule is removably attached to the flange for use of the capsule in a beverage preparation device, and the carrier disk is provided between the lid and the filter, said carrier disk comprising multiple preformed outlet openings suitable for draining the prepared beverage from the inner space when the capsule is used in the beverage preparation device.

In the example of a capsule comprising roast and ground coffee as a beverage ingredient, the specific structure of the capsule allows when the capsule is extracted in a beverage preparation after removal of the lid to get a coffee with limited formation of foam and crema.

This freshly brewed coffee has the main characteristics of a filter-like coffee with little crema, quickly disappearing to leave only a crown of crema around the cup. The result-in-cup is a coffee having a low body, little acidity, and little bitterness with absence of harsh, while being aromatic, soft, smooth and sweet.

In the proposed capsule, the carrier disk is positioned inside the capsule at a distance from the lid comprised between 0.1 mm and 2 mm. This allows avoiding compression of the coffee bed in the coffee machine's brewing chamber and possible interaction between the carrier disk and the tearing surface of the extraction plate of the beverage preparation device

As proposed, the thickness of the carrier disk is comprised between 0.05 mm and 1.5 mm, preferably between 0.1 mm and 1 mm, most preferably between 0.5 mm and 0.8 mm which gives enough stiffness to the carrier disk to resist to ejection during extraction, or after extraction due to the pressure of the swollen coffee bed.

The carrier disk comprises openings that are circular or oblong openings. The proposed openings shape is optimized for an easy manufacturing and a lower tooling cost. However, other shape of the opening may be selected depending on the result in cup to be obtained.

In a preferred way, the openings have a diameter comprised between 0.2 mm and 3 mm, most preferably between 0.5 mm and 1 mm. These dimensions have been calculated for a leak rate of approximately 300 ml/min.

In the proposed solution, the carrier disk comprises between 50 and 150 openings, preferably between 60 and 120 openings, most preferably between 80 and 100 openings. Such a structure with multiple openings avoids possible channeling of the water within the coffee bed during extraction.

In addition, and also contributing to avoiding the channeling effect, the openings are homogeneously distributed on the surface of the carrier disk.

Preferably, the carrier disk is made of Aluminum. This allows an easy recycling in the conventional aluminum stream when the capsule is done in aluminum.

Hence, as a preference, the capsule body, the lid, and the carrier disk are each mainly made from aluminum. The use of aluminum ensures a better coffee protection and a longer shelf life. Additionally, the end of life of the capsule is easier and recycling is easier.

In an alternative way, the carrier disk is made of plastic or of a laminated plastic element.

In this specific capsule structure, the filter element is disk-shaped and comprises a layer of non-woven material adapted to prevent coffee drain to go through and reducing the formation of a crema layer.

Preferably the filter is compostable and/or biodegradable and may be made of cellulose-based material.

The proposed filter comprises a thickness between 0.005 mm to 0.3 mm, an air permeability in the range of 100 to 5000 l/m²/s according to ISO 9237 and a weight in the range of 5 to 600 g/m².

The current envisaged solution, the filter is assembled on the carrier disk. This allows an easy processing in the assembling process of the capsule. Additionally, the filter may be fixed onto the carrier disk.

The lid of the capsule comprises a free pull tab protruding from the lid. The pull tab is integral with the lid allowing to remove the full lid. This handling and opening are then easier.

In a proposed embodiment, the lid comprises at least an aluminum layer to ensure a better shelf life of the coffee in the capsule.

In addition, the lid may further comprise a plastic layer and/or a heat seal layer to ensure food grade compatibility for sealing the lid onto the flange of the capsule.

The claimed lid has a thickness between 0.01 mm and 0.05 mm.

The proposed capsule comprises a beverage ingredient. Preferably the beverage ingredient is ground coffee, preferably in an amount of at least 4 g, preferably between 4.5 g and 15 g.

Also, the invention provides a system as described herein.

The system of the invention aims at preparing a beverage. It comprises an exchangeable capsule and a beverage preparation device with a fluid dispensing device capable of feeding an amount of a fluid, such as water, with a pressure between 0.1 bar and 20 bar to the capsule, and with a brewing chamber, comprising a first part for holding the capsule and a second part for closing the brew chamber.

The claimed system proposes to use the exchangeable claimed capsule in the beverage preparation device where the second part of the brewing chamber of the beverage preparation device comprises an extraction plate for engaging with the exchangeable capsule at the second end of the sidewall when the brew chamber holding the capsule is closed, the extraction plate comprising a tearing surface facing, in use, the carrier disk at the second end of the capsule, wherein the carrier disk of the capsule in use in the closed brewing chamber is not altered by the tearing surface of the extraction plate.

According to the invention, the extraction of the beverage ingredient is an extraction made at a pressure below 8 bar, more preferably below 5 bar.

Furthermore, the invention provides a method of manufacturing a capsule suitable for preparing a beverage as claimed.

Said manufacturing method comprises the following steps:
providing a substantially rigid capsule body having a circumferential sidewall extending around an inner space to be at least partially filled with a beverage ingredient suitable for preparing the beverage, and a rigid base wall covering the inner space at a first end of the circumferential wall; the base wall being integral with the capsule body,
filling the inner space with an amount of the beverage ingredient through an open filling side of the capsule body opposite the base wall,
inserting a filter in the inner space after filling of the inner space with the beverage ingredient
inserting a carrier disk over the filter in the inner space, optionally the filter and carrier disk being inserted in the inner space of the capsule at the same time, and
closing the open filling side by attaching a lid to a flange of the capsule body extending over the open filling side,
wherein the lid is provided with a pull tab and is removed from the capsule prior to the use of the capsule, and
wherein the carrier disk comprises multiple outlet openings through which in use a prepared beverage may flow out of the capsule, which outlet openings are fluid tightly closed by the lid extending over the opening filling side.

Specific embodiments of the invention are described in the following detailed description. The objects are achieved by the present invention, i.e. a capsule, a system and a capsule manufacturing method.

### BRIEF DESCRIPTION OF THE DRAWINGS

The invention is further described with reference to the following examples and drawings, which form part of the present invention. The drawings are not in any way meant to reflect a limitation of the scope of the invention, unless this is clearly and explicitly indicated. It will be appreciated that the invention as claimed is not intended to be limited in any way by these exemplary embodiments and illustrations.

It is noted that the figures are only schematic representations of embodiments of the invention that are given by way of non-limiting example.

Embodiments of the present invention will now be described, by way of examples, with reference to the accompanying figures in which:

FIG. 1a is a perspective side view of a capsule tightly closed before use in a beverage preparation device, according to the invention;

FIG. 1b is a perspective side view of a capsule in which the lid is partially removed, according to the invention;

FIG. 1c is a perspective side view of a capsule in which the lid has been removed and ready to be used in a beverage preparation device, according to the invention;

FIG. 2a is a schematic cross-sectional view of a capsule according to a first embodiment of the invention;

FIG. 2b is an enlarged view of an identified bottom portion of the capsule of FIG. 2a;

FIG. 2c is a view of the carrier disk of the capsule of FIG. 2a;

FIG. 3a is a schematic cross-sectional view of a capsule according to an improved solution of the first embodiment of the invention;

FIG. 3b is an enlarged view of the capsule of FIG. 3a;

FIG. 4 is a schematic view of a capsule according to a second embodiment of the invention;

FIG. 5 is a schematic view of a capsule according to a third embodiment of the invention;

FIG. 6 is a schematic view of a capsule according to a fourth embodiment of the invention;

FIG. 7 is a schematic view of a capsule according to a fifth embodiment of the invention;

FIG. 8 is a schematic view of a first process for assembling the filter and carrier disk or the carrier disk in the capsule according to one or more of the proposed embodiments;

FIGS. 9a, 9b and 9c are schematic views of a second process for assembling the filter and carrier disk or the carrier disk in the capsule according to one or more of the proposed embodiments;

FIG. 10 is a schematic view of a third process for assembling the filter and carrier disk or the carrier disk in the capsule according to one or more of the proposed embodiments;

FIGS. 11a and 11b are schematic views of a fourth process for assembling the filter and carrier disk in the capsule according to one or more of the proposed embodiments;

FIG. 12 is a schematic view of a fifth process for assembling the filter and carrier disk or the carrier disk in the capsule according to one or more of the proposed embodiments;

FIG. 13 is a schematic view of a sixth process for assembling the filter and carrier disk or the carrier disk in the capsule according to one or more of the proposed embodiments;

FIG. 14 is a schematic view of a seventh process for assembling the filter and carrier disk or the carrier disk in the capsule according to one or more of the proposed embodiments;

FIG. 15 is a schematic view of an eighth process for assembling the filter and carrier disk or the carrier disk in the capsule according to one or more of the proposed embodiments.

### DETAILED DESCRIPTION

As used in this specification, the words “comprise”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

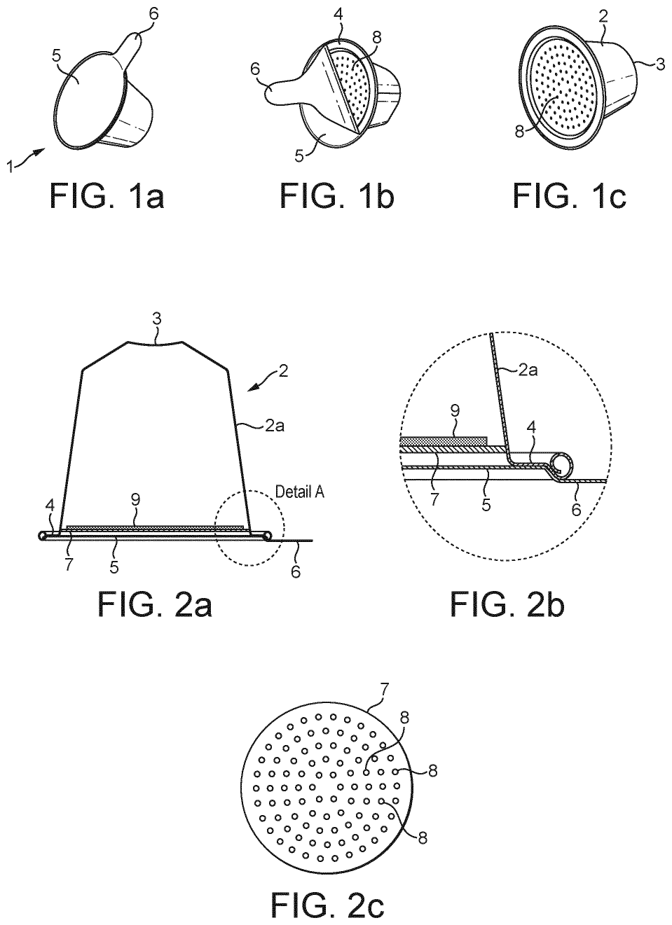

FIG. 1a shows a capsule 1 according to the invention before use in a beverage preparation device, defined as storage state. Using the reference of FIG. 2a, the capsule 1 of FIG. 1a, comprises a capsule body 2. The body 2 comprises a frusto-conical sidewall 2a extending circumferentially around an inner space of the body. The capsule further comprises a rigid base wall 3 integral with the capsule body 2 closing off the inner space at a first end of the side wall of the capsule body 2. A flange 4 extends radially outwardly from a second end of the side wall of the capsule body 2a. At the second end of the side wall the capsule body 2 has an open filling side.

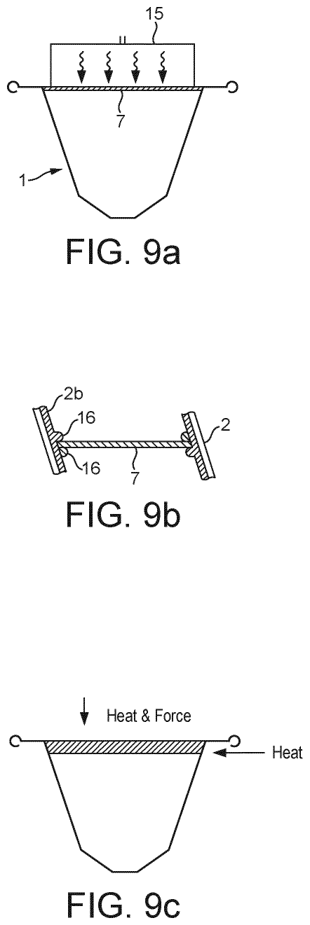

As usual, the capsule body 2 is processed to be food grade and in most of the cases comprises a lacquer layer or a polymer film layer (identified as 2b in FIG. 9b) applied on the inside of the capsule body.

The capsule further includes a lid 5 that is attached to the flange 4 of the capsule body thereby closing hermetically the capsule. The lid 5 may be manually removed from the capsule by pulling on a pull tab 6. In the present case, the pull tab 6 is integral with the lid 5 but alternative solutions are available.

The lid 5 is a flexible sheet-like foil made of aluminum with an optional lacquer layer or a polymer layer on the sealing side.

In case the lid 5 comprises a lacquer layer on its sealing side, the thickness of the lacquer layer may be from 0.003 mm to 0.03 mm. In case the lid 5 comprises a polymer layer on the sealing side, the thickness of the polymer layer may be from 0.01 mm to 0.05 mm.

The lid 5 which is intended to be removed using the pull tab is attached to the flange 4 using an adhesive layer. The adhesive material is applied in the form of a layer of adhesive material and may be, for example, a layer of heat-seal lacquer or a polymer film layer.

As an example, the sealing layer forming the adhesive material may be a layer between 0.003 mm and 0.03 mm.

The layer of adhesive material allows removal of the lid 5 to the flange 4 of the capsule without any damage to the capsule 1.

The inner space of the capsule is filled with a beverage ingredient before the capsule is closed. In the present case, the capsule is filled with a coffee bed of roast and ground coffee before the capsule is tightly closed with the lid 5 to maintain freshness of the roast and ground coffee. The weight of the coffee is in the range of 4 g to 15 g depending on the size of the capsule. However, tea, milk or chocolate ingredients may be envisaged.

The capsule of FIG. 1b shows the capsule of FIG. 1a in which the lid 5 is partially removed by tearing on the pull tab 6 and in FIG. 1c the same capsule in which the lid 5 is fully removed. As can be seen, the second end of the capsule (filling side) is no longer closed and presents on the inside of the capsule a membrane, defined as a carrier disk 7. The carrier disk 7 comprises multiple preformed outlet openings 8 for the beverage (here coffee) prepared in the beverage preparation device.

The preformed outlet openings 8 of the carrier disk 7 are covered by the lid 5 of the capsule thereby closing the capsule to keep hermetic sealing of the inner space of the capsule for ensuring freshness of the beverage ingredient inside the capsule during storage.

As will be seen in the cross-sectional views of the various embodiment of the capsule of the invention (see for example FIG. 2a), the capsule further comprises in its inner space a filter element 9 positioned between the coffee bed and the carrier disk 7. The filter element 9 prevent solid particles of the beverage ingredient, for example coffee particles or tea leaves, to flow out of the capsule inside the end-consumer cup during extraction.

In the proposed invention, the capsule body 2 and the lid 5 are each mainly made from aluminum.

However, other material may be envisaged for the capsule body and the lid.

For example, the capsule body and the lid may be made of plastic polymer material, or the capsule body and the lid may be made of paper-based material.

As is understood, the capsule of the invention is extracted using a conventional high-pressure beverage preparation device compatible with conventional Nespresso® coffee capsules. The beverage preparation device comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber, the second part of the brewing chamber comprising an extraction plate presenting a tearing surface for engaging with the capsule at its second end opposite its base wall.

Summarizing a conventional extraction process of a closed capsule in the beverage preparation device: the capsule is inserted in the brewing chamber of the beverage preparation device. The fluid dispensing device feeds an amount of a fluid, such as water, to the capsule through the base wall 3 inside the capsule to make the coffee infused and then extracted, As pressure increases inside the capsule, the lid of the capsule comes into contact with the tearing surface of the extraction plate and the lid is altered by said tearing surface leading to the formation of opening which allows the coffee to flow out of the capsule.

The formation of the outlet openings at the surface of the lid by interaction of the lid with the tearing surface for the flow out of the coffee participates to the formation of foam and crema in the preparation process.

The use of conventional capsule (closed capsule) with the above-mentioned process leads to coffee extraction at a pressure between 8 bar and 20 bar.

In the extraction process of a capsule of the invention, the lid of the capsule is removed before insertion of the capsule inside the brewing chamber of the beverage preparation device. The fluid dispensing device feeds an amount of a fluid, such as water, to the capsule through the base wall 3 inside the capsule to make the coffee infused and then extracted. The extracted coffee goes through the filter element 9 and then flows out through the outlet openings of the carrier disk 7. During extraction, the carrier disk 7 (which is at a distance from the flange of the capsule) does not come into contact with the tearing surface of the extraction plate of the beverage preparation device so that the carrier disk 7 is not altered by the tearing during extraction of the capsule.

The use of a capsule of the invention (in a conventional beverage preparation device) leads to coffee extraction at a pressure between 0.1 bar and 6 bar, depending on the quantity of coffee inside the capsule and on the filter element structure.

Due to the fact that the lid is removed from the capsule before its use in the beverage preparation device and as the carrier disk is located inside the capsule (see FIG. 2a for example), there is no interaction between the carrier disk 7 and the tearing surface of the extraction plate.

In more details, when preparing a coffee using a capsule 1 of the invention in a beverage preparation device, the user removes the lid 5 by tearing on the pull tab 6 before inserting the capsule in a beverage preparation machine. The base wall 3 of the capsule body 2 is further pierced and opened by piercing means of a beverage preparation device for supplying water under pressure into the capsule for the preparation of a coffee beverage.

Due to the fact that the capsule is not closed (lid 5 removed and outlet openings accessible) when used in the beverage preparation device, the extraction pressure building up inside the capsule is limited (0.1 to 6 bar) and there is limited formation of foam and crema during extraction.

Hence, because the pressure built up and the sudden pressure drop are not occurring (as with the use of conventional capsule) at the interaction between the coffee/the lid/the opening element(s) with the tearing surface of the extraction plate of the beverage preparation device, the resulting coffee in cup is with little or no crema.

The capsule of the invention allows preparing crema-free coffee, tea, milk or chocolate depending on the beverage ingredient inside the capsule.

FIG. 2a shows a first embodiment of the capsule of the invention. As disclosed, the capsule comprises inside the inner space a carrier disk 7 comprising multiple preformed outlet openings 8.

As presented on FIG. 2b, an enlarged view of the identified bottom part portion of FIG. 2a, the carrier disk 7 is positioned inside the capsule at a distance from the lid 5 comprised between 0.1 mm to 2 mm, the lid 5 being sealed on the flange 4.

This gap between the capsule lid 5 (and so the flange 4 once the lid is removed for extraction) and the carrier disk 7 provides a recess for the tearing surface of the extraction plate of the beverage preparation device to protrude inside the capsule without contacting the carrier disk 7 and hence the coffee in the capsule.

The carrier disk 7 is a substantially round membrane as shown in FIG. 2c, and its diameter is approximately the inner diameter of capsule at the location where the carrier disk 7 is positioned/inserted/maintained depending on the assembling process.

Hence, in the proposed embodiment, the diameter of the carrier disk 7 is around 29.5 and 30.5 mm.

In the proposed embodiment, the carrier disk is made of Aluminum. Its thickness is about 0.3 mm but may vary between 0.1 mm and 1 mm.

In an alternative solution, the carrier disk 7 may be made of plastic or of a laminated membrane comprising for example, in polyolefins such as polypropylene, polyethylene or any other semi crystalline polymer. The carrier disk 7 may also be made of paper-based material, like a coated paper or a laminated paper.

As can be seen on the FIG. 2c, the preformed outlet openings 8 are circular openings homogeneously distributed on the surface of the carrier disk. This homogeneous distribution of the outlet openings will ensure a homogeneous flux of the coffee flowing out of the capsule 1. This also helps to avoid creation of channel with the beverage (coffee bed) inside the capsule.

The openings have a diameter set around 0.8 mm to 0.85 mm, but the diameter may vary between 0.2 mm and 3 mm, most preferably between 0.5 mm and 1 mm.

The number of preformed outlet openings may vary depending on the size of the capsule and on how fast the delivery of coffee is wished. In the disclosed embodiment, the carrier disk 7 comprises between 10 to 120 openings, preferably around 90 and in the presented embodiment 92.

In an alternative embodiment, the preformed outlet openings may be of oblong shape.

As presented, the capsule further comprises a filter element 9 that during a possible assembling process is positioned on the ingredient bed (coffee bed for example) after the filling of the capsule, and the carrier disk 7 is positioned between the filter element and the lid 5.

When the capsule is turned up-side down and as presented in the enlarged view of FIG. 2b, the filter element 9 lies on the carrier disk 7. The filter element is then supported by the carrier disk 7 inside the capsule. The filter is maintained flat inside the capsule and is not contacted by the tearing surface of the extraction plate of the beverage preparation device during extraction.

The use of a two-piece design may enable the use of none-sealable filter materials which could be an advantage for sustainability.

As proposed in this embodiment, the filter element 9 is circular (disk-shaped) with a smaller diameter than the diameter of the carrier disk 7, i.e. between 28 mm and 30.5 mm, and in general with 0.1 mm less than the disk carrier.

However, in an alternative embodiment, the diameter of the filter element 9 could be similar to the one of the carrier disk 7.

The filter element 9 is made of non-woven material adapted to prevent/refrain coffee drains to go through too quickly during extraction of the beverage and reducing the formation of a crema layer.

The filter is preferably made of a compostable and/or biodegradable material and may be made of cellulose-based material with the below technical features. It may for example be a paper-based filter element.

The filter element 9 of the proposed embodiment comprises a thickness between 20 to 300 microns, an air permeability in the range of 100 to 5000 l/m²/s according to ISO 9237, and a weight in the range of 5 to 600 g/m². It may for example be a paper-based filter element.

The filter elements may comprise a layer of non-woven material connected by any known means to another filtering layer.

In the proposed embodiment of FIGS. 2a to 2c, the filter element 9 and carrier disk 7 are independent elements positioned on one another. However, they may be assembled together, for example by gluing. This will then change the assembling process in the capsule as the insertion of the filter and carrier disk will be made in one step.

The proposed circular carrier disk 7 may have a tapered shape on its perimeter so as to fit (force fit) into capsules having truncated cone shape. However, other alternative shape and arrangement of the carrier disk inside the capsule may be envisaged.

It is important that the carrier disk 7 and filter element 9 remains in place inside the capsule when the lid 5 is removed and the capsule 1 extracted in the beverage preparation machine. Several assembling process may be considered and will be later on disclosed in connection with the proposed embodiments of the capsule according to the invention.

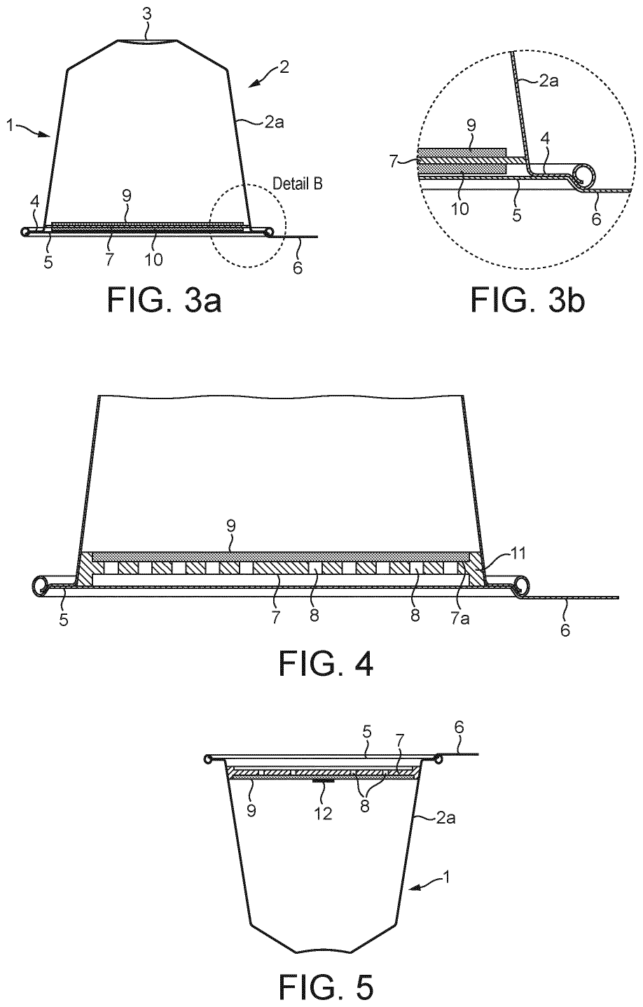

An improved solution of the first embodiment of the invention is presented in FIGS. 3a and 3b presenting the addition of a second non-woven filter element 10. The second filter element 10 is also a non-woven filter. It is positioned onto and fixed to the carrier disk on the side facing the lid (coffee opposing side—facing directly the pyramid plate of the beverage preparation device).

The purpose of this filter is to allow transversal flow of coffee in case the perforations match the flat top surface of the truncated pyramids.

As mentioned, the second filter element is made of non-woven material, however, it can be made of any suitable element compatible with the required function.

The second filter element 10 is positioned inside the capsule and does not contact the lid.

The second filter element 10 may have the following dimensions from 28 mm to 30.5 mm.

In the present embodiment the second filter element 10 is substantially circular with a diameter slightly smaller than the carrier disk 7.

The assembling process and configuration proposed in connection with FIGS. 2a to 2c may still apply with this improved solution.

FIG. 4 proposes a partial cross-sectional view of a capsule in which the carrier disk 7 is made of plastic. The carrier disk is an injected plastic element comprising multiple outlet openings 8 and a seat 7a on its side facing the beverage ingredient (coffee for example) to accommodate the filter element 9.

The outlet openings 8 of the carrier disk are distanced from the lid of about 0.6 mm. Thanks to this assembly, there is no interaction between the tearing surface of the extraction plate of the beverage preparation device and the carrier disk 7.

The carrier disk 7 has a diameter similar to the internal diameter of the capsule at the location where is positioned. Hence a diameter is comprised between 29.5 mm and 30.5 mm.

As previously disclosed the preformed outlet openings 8 are circular openings homogeneously distributed on the carrier disk and having a diameter of about 0.8 mm to 0.85 mm.

In the proposed embodiment, the carrier disk 7 comprises about 90 preformed outlet openings. The number of outlet openings may comprise around 10 to 120 preformed outlet openings.

The filter element 9 has similar characteristics as the one described in connection with FIGS. 2a to 2c. Additionally, it may be fixed on the carrier disk 7 by any known means or just retained on it thanks to shape adjustment.

The carrier disk further comprises tapered feet 11 to fit straight in the capsule during assembly. As proposed in this embodiment, the feet 11 may lay on the lid 5. At the feet location, the thickness of the carrier disk 7 may be around 1.6 to 2.0 mm (for an Original Line Nespresso® capsule) but it indeed may depend on the size of the capsule.

In the embodiment presented in FIG. 5, the carrier disk 7 is, as in the embodiment of FIG. 4, an injected plastic element. The filter element 9 is assembled on the carrier disk 7 in a seat 7a. The filter element 9 remains loose in the seat 7a but is maintained in said seat on the carrier disk 7 thanks to one sealing point 12.

Hence the filter element 9 is sealed in one point to the carrier disk 7. One sealing point 12 may be sufficient for maintaining the filter element 9 on the carrier disk 7, however additional sealing points may be envisaged.

The sealing may be made by different sealing technologies such as thermal or ultrasonic sealing. This list is not exhaustive.

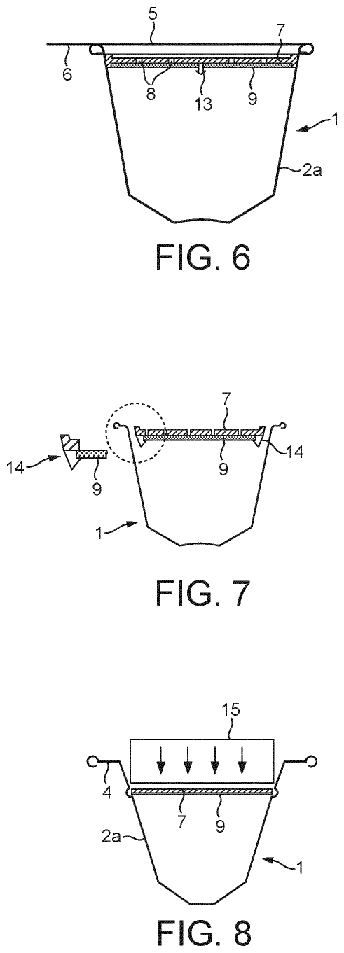

In the embodiment presented in FIG. 6, the carrier disk is, as in the embodiment of FIG. 4, an injected plastic element. The filter element 9 is assembled on the carrier disk 7 in a seat 7a presenting a corresponding shape.

Additionally, the filter element 9 remains loose in the seat 7a and is maintained on the carrier disk 7 using a pin 13.

The pin is preferably a plastic pin 13. It maintains the filter element 9 in the seat 7a approximately in the middle of the filter. However, other locations may be envisaged.

FIG. 7 propose an alternative solution to the embodiments presented in FIGS. 5 and 6, to maintain the filter element 9 on the carrier disk 7.

The carrier disk 7, here comprises at least one clip 14 located on the perimeter of the carrier disk 7 ensuring that the filter element 9 remains in the seat 7a. The clip 14 may be continuous along the perimeter of the carrier disk 7 or several clips 14 may be positioned along the perimeter of the carrier disk 7.

The clip 14 is integral with the carrier disk 7, i.e. it is made of plastic and injected with the carrier disk 7.

In the proposed invention it is important to maintain the carrier disk and the filter in the capsule after having removed the peelable membrane. Indeed, after removal the peelable membrane for the capsule to be used in the beverage preparation device, if the carrier disk and the filter are just laying on the beverage ingredient, during handling and insertion of the capsule in the beverage dispensing machine, the carrier disk, filter and even the beverage ingredient may fall from the capsule body.

It is then important to ensure that the carrier disk and filter are maintained inside the capsule.

The disclosed capsule elements taken in combination contributes to the filter-like in-cup profile of the obtained coffee.
Filter element 9 that may be paper based, to retain extraction of fine particles from the coffee bed into the cup. The filter element also contributes to a slow release of pressure in the coffee bed during extraction, reduces crema formation and contributes to a smoother filter-like in-cup profile.
The perforated aluminum carrier disk, to avoid interaction between coffee bed and tearing surface of the extraction plate of the beverage device, again contributing to a slow release of the pressure in the coffee bed during extraction, reducing crema formation and contributing to a smooth filter-like in-cup profile.
Absence of closing membrane (as it is peeled off before the use of the capsule in the beverage device), reducing coffee bed compaction during the initial phases of extraction and eliminating water resistance during extraction, again contributing to reduce crema formation and to a smoother filter-like in-cup profile.

Proposed assembling process will be disclosed in FIGS. 8 to 15.

FIG. 8 presents a first process for assembling the filter and carrier disk or the carrier disk alone in the capsule.

As presented, a force between 10 N to 500 N is applied on the surface of the carrier disk 7 thanks to a specific tooling to push down the carrier disk into the frustoconical capsule body 2.

The capsule body being of tapered shape, the disk carrier will exercise a force on the horizontal direction against the sidewall of the capsule body that will maintain the carrier disk in position inside the capsule body.

The specific tooling may be relatively simple to build as presented in the figure. Its dimensions should be defined so as to be insertable in the capsule body for applying the required pressure to ensure good positioning of the carrier disk in the capsule body. It could be built using a pressure piston 15 for example, but alternative constructions may be envisaged. This process could be considered as a force-fitting process.

This process may be applied to:
The carrier disk in the capsule body after filling of the beverage ingredient and filter insertion; or
To both the carrier disk and filter when the filter is first positioned on/assembled with the carrier disk.

Hence, the proposed process may apply to one or more of the described embodiments.

The assembling process of FIGS. 9a, 9b and 9c uses the force fitting concept (as disclosed in connection with FIG. 8) and in addition applies heating during and/or after the positioning of the carrier disk 7.

In the proposed embodiment, the pressing piston 15 applies a force of about 50 N to 100 N and in addition during the application of the force, the pressing piston 15 is heated (FIG. 9a). The heat applied to the carrier disk 7 (that can also be connected or hold the filter element 9 but which is not here presented) inside the capsule body 2 contacting the sidewall induces the lacquer 2b applied on the inside of the capsule body 2 to be melted and creates a bond between the inner part of the sidewall (FIG. 9b) and the carrier disk, that will maintain the carrier disk inside the capsule body once the temperature cools down. The bound may be in the form of a bead 16 as presented in FIG. 9b.

Heat could also be applied on one or both sides of the capsule body 2 from the outside of the capsule 1. Both heating sources (from pressure piston and from side heating) could be combined if needed as can be schematically seen in FIG. 9c.

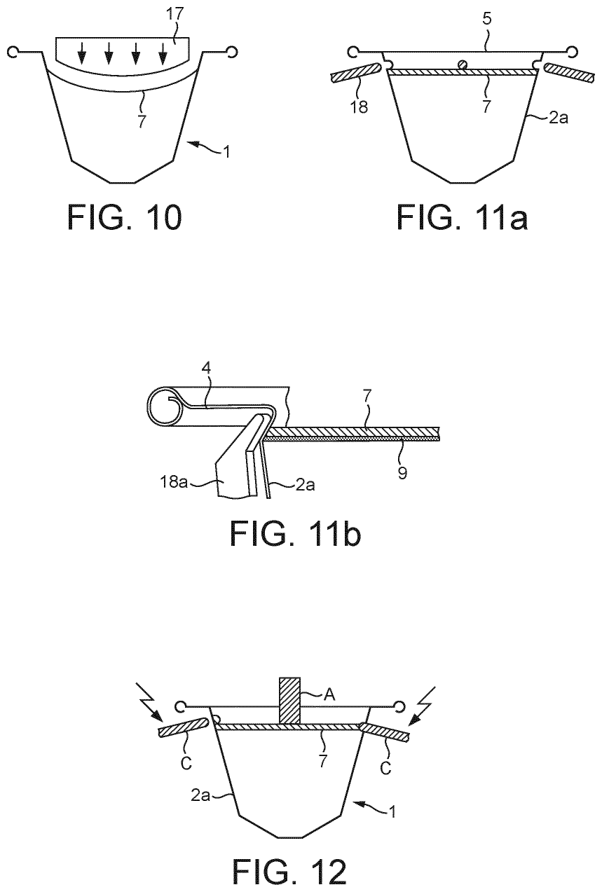

The assembling process proposed in FIG. 10 uses the force fitting process disclosed in connection with FIG. 8 with a higher pushing pressure in order to induce a deformation of the carrier disk 7.

A pushing tool 17 having a convex shape may be used.

The pushing tool 17 pushes down the carrier disk 7 into the capsule and slightly deforms the carrier disk 7 into a concave disk, the carrier disk 7 is not anymore flat. Once positioned inside the capsule body 2, the carrier disk 7 cannot come back to its initial flat shape as lateral forces apply preventing any movement of the carrier disk 7. The carrier disk 7 is then maintained inside the capsule body 2 at a distance from the flange (as already discussed in connection with FIGS. 2a and 2b).

Using this proposed assembling process, a capsule according to FIG. 1c may be obtained.

The assembling process is disclosed in a connection with the carrier disk 7 but could also be used in an embodiment in which the filter element 9 and the carrier disk 7 are linked together, as presented for example in FIGS. 2 and 3.

FIGS. 11a and 11b propose assembling processes in which the carrier disk 7 of the capsule is clamped inside the capsule body through local deformation of the capsule from the outside of the capsule.

In the assembling process of FIG. 11a, once the carrier disk 7 (or carrier disk 7 plus filter element 9) is inserted inside the capsule body 7, a clamping tool 18 presses the capsule body from the outside to induce a local deformation of the capsule body just above the level of the carrier disk 7 position so that the carrier disk 7 is maintained in position inside the capsule.

The local deformation of the outside of the capsule body from the outside is made on its circumference, for example, at every 90°. This is enough to ensure efficient holding of the carrier disk 7.

The proposed assembling process (clamping process) can also be associated with force fitting process (as presented in FIG. 8), and heating (as presented in FIG. 9) for melting of the internal capsule lacquer layer to create a bead 16.

In a variant of the above presented clamping process, FIG. 11b proposes to make the local deformation on at the location of the edge of the flange, for example 3 deformation around the edge of the flange using a clamping tool 18a, to maintain the carrier disk 7 inside the capsule body.

This variant can be done before or after the lid is positioned and/or sealed. Incase this variant is used the distance between the carrier disk 7 and the flange of the capsule body will be smaller than the one when the local deformation is made on the sidewall of the capsule body (FIG. 11b).

Referring now to FIG. 12, the assembling process discloses the use of induction heating to provide maintaining means of the carrier disk 7 inside the capsule body 2.

It Is proposed to seal the carrier disk made of aluminum on the inside of the capsule using an anode A directly applied on the carrier disk 7 and a cathode C applied on the sidewall on the outside of the at the capsule. A localized heat is generated by a high electric current applying through the contact area of welding.

The process can be combined with the force fitting process as disclosed previously where a pressure is applied onto the carrier disk 7. When applying pressure onto the disk 7, the perimeter of the carrier disk 7 will enter into contact through its edge with the inner side of the capsule sidewall 2a. Applying a localized heat generated by a high electric current will create a welding on the contact area.

The welding can be made on one or more points to ensure efficient holding of the carrier disk 7. For example, four welding points located at every 90° around the circular perimeter of the carrier disk 7 perfectly work.

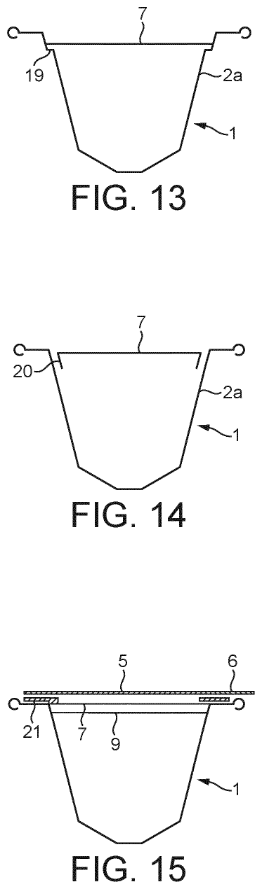

The assembling process presented in FIG. 13 proposes to provide the capsule 1 with a staking shoulder 19 just below the flange 4. The staking shoulder 19 is a retracting flat shoulder made on the sidewall 2a of the capsule body 2. During assembling, the carrier disk 7 is inserted inside the capsule body 2.

In case the staking shoulder 19 is slightly conical, it could maintain the carrier disk 7 in position inside the capsule body 2.

In case the staking shoulder is not conical, then carrier disk 7 can be sealed (by any known means) on the flat surface of the staking shoulder 19.

In any case and as previously mentioned the filter element 9 may be positioned and/or attached to the carrier disk 7 before the carrier disk 7 is inserted inside the capsule body 2.

FIG. 14 presents a proposed geometry for the carrier disk 7 and related assembling process.

The carrier disk 7, here made of an aluminum-based material, is not anymore completely flat but has a surrounding conical flange 20 along its perimeter. The conical flange 20 forms an angle with the flat surface of the carrier disk 7. This angle is similar to the frusto-conical angle of the capsule body 2 so as to fit with the sidewall 2a inside the capsule body 2.

The holding of the carrier disk 7 into the capsule 1 results from having two conical surfaces with very close angle proximate to each other.

Hence, in terms of assembling, the carrier disk 7 (with the filter element 9 or not) is simply inserted into the capsule body 2 until the two conical surfaces contact each other thereby achieving holding the carrier disk 7 in position inside the capsule.

FIG. 15 proposes an additional way to maintain the carrier disk 7 in position inside the capsule body 2. In this embodiment, a membrane 21 comprising a precut opening with dimension smaller than the opening of the capsule body (second end of the capsule body) is sealed on the flange 4 of the capsule 1 after the capsule has been filled with beverage ingredient, the filter element 9 and carrier disk 7 inserted inside the capsule body.

The lid 5 (with pull tab 6) is then sealed on the membrane 21 to hermetically close the capsule.

During use, consumer will remove the lid 5 using the pull tab 6, the membrane 21 will remain in place on the capsule (sealed on the flange) and maintain the carrier disk 7 inside the capsule. Thanks to adequate sizing of the membrane, the carrier disk 7 will lay on the membrane 21 and be maintained inside the capsule.

The presented embodiments for the carrier disk as well as for the assembling process may be combined whenever needed and possible to improve the holding of the carrier disk 7 (with or without the filter element 9) inside the capsule body 2.

The presented capsule may be associated with sealing means located on the flange of the capsule ensuring liquid tightness between the capsule and the injection part of the beverage production machine. For instance, the sealing means may be a silicon ring applied on the base of the flange and sidewall of the capsule body, or one or more protrusions, or bridges formed on the flange (and integral with the flange). Such sealing means (not represented) participates to the liquid-tight arrangement with the beverage production machine.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. Capsule for preparing a beverage comprising
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall,
a flange arranged circumferentially at a second end of the sidewall of the base body,
a lid covering the inner space at a second end of the sidewall opposite the base wall and tightly closing the capsule, and
a filter element positioned in the inner space of the capsule between the beverage ingredient and the lid; and
a carrier disk provided in the inner space of the capsule,
the lid is removably attached to the flange for use of the capsule in a beverage preparation device, and
the carrier disk is provided between the lid and the filter, said carrier disk comprising multiple preformed outlet openings suitable for draining the prepared beverage from the inner space when the capsule is used in the beverage preparation device.

2. Capsule for preparing a beverage according to claim 1, wherein the carrier disk is positioned inside the capsule at a distance from the lid of between 0.1 mm and 2 mm.

3. Capsule for preparing a beverage according to claim 1, wherein the thickness of the carrier disk is comprised between 0.05 mm and 1.5 mm.

4. Capsule for preparing a beverage according to claim 1, wherein the openings are circular.

5. Capsule for preparing a beverage according to claim 1, wherein the openings have a diameter of between 0.2 mm and 3 mm.

6. Capsule for preparing a beverage according to claim 1, wherein the carrier disk comprises between 50 and 150 openings.

7. Capsule for preparing a beverage according to claim 1, wherein the openings are homogeneously distributed on the surface of the carrier disk.

8. Capsule for preparing a beverage according to claim 1, wherein the carrier disk is made of aluminum.

9-10. (canceled)

11. Capsule for preparing a beverage according to claim 1, wherein the filter is disk-shaped and comprises a layer of non-woven material adapted to prevent coffee drain to go through and reducing the formation of a crema layer.

12. Capsule for preparing a beverage according to claim 1, wherein the filter comprises a thickness between 0.005 mm to 0.3 mm, an air permeability in the range of 100/m²/s to 5000 l/m²/s according to ISO 9237 and a weight in the range of 5 g/m² to 600 g/m².

13. Capsule for preparing a beverage according to claim 1, wherein the filter is assembled on the carrier disk.

14. Capsule for preparing a beverage according to claim 1, wherein the lid comprises a free pull tab protruding from the lid.

15. Capsule for preparing a beverage according to claim 1, wherein the lid comprises at least an aluminum layer.

16. (canceled)

17. Capsule for preparing a beverage according to claim 1, wherein the lid has a thickness between 0.01 mm and 0.05 mm.

18. Capsule for preparing a beverage according to claim 1, where in the beverage ingredient comprises ground coffee in an amount of between 4.5 and 15 g.

19. System for preparing a beverage comprising an exchangeable capsule and a beverage preparation device with a fluid dispensing device capable of feeding an amount of a fluid, such as water, with a pressure between 0.1 bar and 20 bar to the capsule, and with a brewing chamber, comprising a first part for holding the capsule and a second part for closing the brew chamber,
wherein the exchangeable capsule comprises
a substantially rigid capsule body having a circumferential sidewall extending around an inner space of the capsule, said inner space being at least partially filled with a beverage ingredient suitable for preparing the beverage,
a rigid base wall covering the inner space at a first end of the sidewall, the base wall being integral with the capsule body, which base wall is pierced in use by at least one knife of the fluid dispensing device for the beverage preparation device for feeding the amount of fluid,
the exchangeable capsule comprising a lid covering the inner space at a second end of the circumferential wall opposite the base wall and tightly closing the capsule before use, wherein the lid is removed from the capsule when the capsule is used in the beverage preparation device,
a carrier disk provided in the inner space of the capsule and comprising multiple preformed outlet openings suitable for draining the prepared beverage from the inner space when the capsule is used in the beverage preparation device
wherein the second part of the brewing chamber comprises an extraction plate for engaging with the exchangeable capsule at the second end of the sidewall when the brew chamber holding the capsule is closed, the extraction plate comprising a tearing surface facing, in use, the carrier disk at the second end of the capsule, wherein the carrier disk of the capsule in use in the closed brewing chamber is not altered by the tearing surface of the extraction plate.

20. System for preparing a beverage according to claim 19 wherein the extraction of the beverage ingredient is an extraction at a pressure below 8 bars.

21. Method of manufacturing a capsule suitable for preparing a beverage comprising:
providing a substantially rigid capsule body having a circumferential sidewall extending around an inner space to be at least partially filled with a beverage ingredient suitable for preparing the beverage, and a rigid base wall, integral with the capsule body covering the inner space at a first end of the circumferential wall,
filling the inner space with an amount of the beverage ingredient through an open filling side of the capsule body opposite the base wall,
inserting a filter in the inner space after filling of the inner space with the beverage ingredient
inserting a carrier disk over the filter in the inner space, optionally the filter and carrier disk being inserted in the inner space of the capsule at the same time, and
closing the open filling side by attaching a lid to a flange of the capsule body extending over the open filling side,
wherein the lid is provided with a pull tab and is removed from the capsule prior to the use and the capsule, and
wherein the carrier disk comprises multiple outlet openings through which in use a prepared beverage may flow out of the capsule, which outlet openings are fluid tightly closed by the lid extending over the opening filling side.

22. (canceled)
